(19) United States
(12) Patent Application Publication
(10) Pub. No.: US 2015/0056424 A1
(43) Pub. Date: Feb. 26, 2015

(54) PRINTED ELASTOMERIC MATERIALS

(71) Applicant: Clopay Plastic Products Company, Inc., Mason, OH (US)

(72) Inventor: Iyad Muslet, West Chester, OH (US)

(21) Appl. No.: 14/468,160

(22) Filed: Aug. 25, 2014

Related U.S. Application Data
(60) Provisional application No. 61/869,249, filed on Aug. 23, 2013.

(51) Int. Cl. B32B 3/10; B32B 7/12; B32B 38/00; B32B 37/18; B32B 37/15; B41F 17/00; B32B 37/12

(52) U.S. Cl. CPC B32B 3/10; B41F 17/00; B32B 7/12; B32B 37/1284; B32B 37/18; B32B 37/153; B32B 38/0012; B32B 38/145; B32B 2250/05; B32B 2038/0028
USPC 428/205; 428/201; 428/203; 156/277; 156/244.11; 156/73.1; 156/229

(57) ABSTRACT

A printed, multi-layered, elastomeric composite sheet material is provided that includes a printed composite layer having an elastomeric film layer bonded to a first substrate layer, where a graphic is printed on a free film surface of the elastomeric film. The composite sheet material further includes a second composite layer, which includes a second film layer bonded to a second substrate layer. The printed composite layer and second composite layer are bonded across at least a portion of the elastomeric film surface and second film surface, which protects the printed graphic on the elastomeric film surface from smearing or rubbing off. Methods of making the composite sheet material are also provided.

### CROSS-REFERENCE TO RELATED APPLICATIONS

Pursuant to 37 C.F.R. §1.78(a), this application claims the benefit of and priority to prior filed, co-pending Provisional Application Ser. No. 61/869,249 filed Aug. 23, 2013, which is expressly incorporated herein by reference in its entirety.

### FIELD OF THE INVENTION

The present invention relates to composite sheet materials that include printed elastomeric films laminated to non-elastomeric materials, as well as methods of making these composite sheet materials. The printed graphics are protected from rubbing off or smearing, so the quality of the printing may be preserved or extended.

### BACKGROUND

Elastomeric materials stretch to fit over or around a larger object, and then retract to provide a snug fit around the object. For instance, elastomeric materials are used in garments to conform to the body and provide a snug fit, such as in active wear. Snug fit is especially important in hygienic products such as diapers, to prevent body fluid leakage. Therefore, elastomeric materials are used in various parts of such hygiene products.

Many absorbent articles, especially those used with babies and toddlers, have an outer cover film printed with decorative designs. These designs are intended to make the diaper visually appealing to the wearer and the caretaker. The elastomeric components of a diaper, such as the diaper ears or side panels, may comprise a significant portion of the visible area of the diaper as it is worn. However, these elastomeric components have not typically been printed with graphics, although the elastic film may be produced with a suitable solid color to enhance the film's appearance.

Several possible obstacles or disadvantages exist that may have historically deterred others from attempting or succeeding at printing on elastomeric materials. First, many of the conventional inks if printed onto elastic films might smear or rub off, unless the printed area was protected with an additional continuous layer, which increases costs and complexity. Additionally, printing a design on an unsupported elastic film, which might stretch during the printing process, would yield a distorted graphic once the stretched film relaxes. Alternatively, printing on a nonwoven or non-elastic substrate and then activating, would most likely also yield a distorted graphic caused by post-activation set or permanent set introduced during the activation process. And protecting a printed graphic applied to a nonwoven, by bonding an elastic film over the printed graphic, suffers from a weakening of the bond between the printed regions of the film and the nonwoven, which makes the composite material susceptible to delamination.

Accordingly, there is a need for new printed elastomeric materials, as well as methods of making them.

### SUMMARY OF THE INVENTION

Embodiments of the present invention are directed to a printed, multi-layered, elastomeric composite sheet material that includes a first composite layer comprising an elastomeric film having a printed graphic, where the printing inks will not smear or rub off during production or use. The quality of the printing and the appearance of the graphics on the elastomeric film are excellent during manufacture, and remain excellent during use of the composite sheet material by the consumer.

In accordance with an embodiment of the present invention, a printed, multi-layered, elastomeric composite sheet material is provided that includes a first composite layer, comprising a first film layer comprising a first elastomeric polymer bonded to a first substrate layer, wherein the first composite layer has a first film surface and a first substrate surface, and wherein a printed graphic is on the first film surface. The printed, multi-layered, elastomeric composite sheet material further includes a second composite layer, comprising a second film layer bonded to a second substrate layer, wherein the first composite layer has a second film surface and a second substrate surface. The first composite layer and the second composite layer are bonded across at least a portion of the first and second film surfaces. For example, the first and second composite layers may be adhesively bonded.

In accordance with another embodiment of the present invention, an absorbent article is provided that includes a waistband component comprising the printed, multi-layered, elastomeric composite sheet material.

In accordance with yet another embodiment of the present invention, a method of making the printed, multi-layered, elastomeric, composite sheet material is provided. The method includes printing a graphic on a first composite layer, wherein the first composite layer comprises a first film layer comprising a first elastomeric polymer bonded to a first substrate layer, wherein the first composite layer has a first film surface and a first substrate surface, and wherein the graphic is printed on the first film surface. The method further includes bonding the first composite layer to a second composite layer comprising a second film layer and a second substrate layer, wherein the first and second film surfaces of the first and second composite layers are bonded across at least a portion of the film surfaces.

In one embodiment, bonding of the first composite layer to the second composite layer includes applying an adhesive composition to at least one of the first or second film surfaces; and pressing the first and second film surfaces together to sandwich the adhesive composition therebetween and thereby adhesively bond the first and second composite layers together.

The first and second composite layers may be formed by bonding the respective film layer to the respective substrate layer. The film and substrate layers may be bonded by extrusion lamination, adhesive lamination, thermal lamination, ultrasonic lamination, calender lamination, or combinations thereof. Activating the multi-layered, elastomeric composite sheet material may be achieved by incremental stretching in a machine direction, a cross direction, at an angle, or any combination thereof.

### BRIEF DESCRIPTION OF THE DRAWINGS

The invention will be more fully understood in view of the drawings, in which:

FIG. 1 is a schematic of a typical cast extrusion process for preparing a composite layer used in making a printed, multi-layered, composite sheet material, in accordance with an embodiment of the present invention;

FIGS. 2A and 2B show exemplary schematics of composite layers used for making a printed, multi-layered, composite sheet material, in accordance with an embodiment of the present invention;

FIG. 3 is a schematic of a printing process for preparing a printed composite layer, in accordance with an embodiment of the present invention;

FIG. 4 is a schematic of a typical adhesive lamination process useful for preparing a printed, multi-layered, composite sheet material, in accordance with an embodiment of the present invention;

FIG. 5 is a schematic of a printed, multi-layered, composite sheet material, in accordance with another embodiment of the present invention;

FIG. 6 is a schematic of a printed, multi-layered, composite sheet material, in accordance with another embodiment of the present invention; and

FIG. 7 is a schematic of a printed, multi-layered, composite sheet material, in accordance with yet another embodiment of the present invention.

### DETAILED DESCRIPTION OF THE INVENTION

The inventor has discovered that a composite layer, comprising an elastomeric film bonded to a substrate such as a nonwoven material, can be printed on the surface of the elastomeric film, yielding a printed image or graphic with excellent print quality. This printed composite layer, which is printed on the free surface of the elastomeric film, can then be bonded to a second composite layer, which includes a second film layer bonded to a second substrate, such that the printed elastomeric film surface is bonded to the second film layer of the second composite, which prevents the printed surface of the composite sheet material from scuffing, rubbing off, or smearing. Other notable advantages afforded by embodiments of the present invention, include but are not limited to, the ability to protect graphics with a clear film; bonding is not compromised between nonwoven and film because the printing is on the elastomeric film not the nonwoven; graphic distortion is avoided because there is little to no permanent set in the composite sheet material; and uniform activation still retains crisp images because of the elasticity of the printed elastomeric film surface. These and other advantages will be afforded by various embodiments of the present invention.

Accordingly, the inventive printed, multi-layered, elastomeric composite sheet materials and methods of making such are disclosed herein.

For the purpose of this disclosure, the following terms are defined:

“Film” refers to material in a sheet-like form where the dimensions of the material in the x (length) and y (width) directions are substantially larger than the dimension in the z (thickness) direction. Films have a z-direction thickness in the range of about 1 μm to about 200 μm, which corresponds to about 0.9 to 200 gsm for many elastomeric films.

“Thin film,” for the purpose of this patent application, refers to any film that is less than 40 gsm, preferably less than 30 gsm.

“Basis weight” is an industry standard term that quantifies the thickness or unit mass of a film or composite product. The basis weight is the mass per planar area of the sheet-like material. Basis weight is commonly stated in units of grams per square meter (gsm) or ounces per square yard (osy).

“Coextrusion” refers to a process of making multilayer polymer films. Exemplary coextrusion processes include, but are not limited, cast coextrusion or blown film coextrusion. When a multilayer polymer film is made by a coextrusion process, each polymer or polymer blend is melted in an extruder. The molten polymers may be layered inside the extrusion die, and the layers of molten polymer films are extruded from the die essentially simultaneously. In coextruded polymer films, the individual layers of the film are bonded together but remain essentially unmixed and distinct as layers within the film. This is contrasted with blended films, where the polymer components are mixed to make an essentially homogeneous blend or heterogeneous mixture of polymers that are extruded in a single layer.

“Blocking” refers to the phenomenon of a material sticking to itself while rolled, folded, or otherwise placed in intimate surface-to-surface contact, due to the inherent stickiness or tackiness of one or more of the material components. Blocking can be quantified by ASTM D3354 “Blocking Load of Plastic Film by the Parallel Plate Method.”

“Skin layer” refers to an outer layer of a coextruded, multilayer film that acts as an outer surface of the film during its production and subsequent processing.

“Composite” refers to a layered structure of sheet-like materials stacked and bonded across at least a portion of the width of the narrowest sheet of material. The respective layers maybe coextensive. The layers may comprise film layers, and substrate layers such as nonwoven materials in sheet form, or combinations thereof. For instance, a composite may be a structure comprising a layer of film and a layer of nonwoven bonded together across their width such that the two layers remain bonded as a single sheet under normal use.

“Free surface” or “free film surface” for a composite of the present invention refer to the side of the film layer that is not bonded to the substrate layer.

“Extrusion lamination” or “extrusion coating” refer to processes by which a film of molten polymer is extruded onto a solid substrate, in order to coat the substrate with the molten polymer film and bond the substrate and film together.

“Adhesive” refers to compositions comprising one or more thermoplastic polymers, one or more tackifier resins, and other optional additives. Adhesives contain 2% or more of tackifier resin. An adhesive is generally used to join or bond two or more materials together by applying the adhesive to at least one material and bringing it into contact under sufficient pressure with at least one other material. Adhesives can be applied continuously over the surface of one or more materials, or they may be applied as spaced-apart stripes, dots, swirls, random lines, or other discontinuous patterns to the material(s).

“Adhesive lamination” refers to processes by which layers of sheet-like materials are bonded together using an adhesive layer between the composite layers. The sheet-like materials may be any solid substrate, such as polymer films, fabrics, etc. Specifically, the sheet-like materials may be composite layers.

“Elastomeric material,” “elastomeric composite,” or “elastomeric composite sheet material” refer to materials, composites, or composite sheet materials that either possess elasticity in their present form or are capable of possessing elasticity after undergoing activation (described below). “Elasticity” refers to the ability of the material, composite, or composite sheet material to extend or stretch at least 50% without breaking or rupturing, and is able to recover substantially to its original dimensions, accounting for set, after the deforming force has been removed. For example, an elastomeric composite sheet material that is 10 cm long should stretch to at least about 15 cm under a suitable stretching force, and then retract to no more than about 12 cm when the stretching force is removed.

“Elastomeric film” or “elastomer film” refer to polymer films that include at least one elastomeric polymer and can be stretched by at least about 150% or more of their original dimension, and which then recover to no more than about 120% of their original dimension in the direction of the applied stretching force. For example, an elastomeric film that is 10 cm long should stretch to at least about 25 cm under a suitable stretching force, and then retract to no more than about 12 cm when the stretching force is removed.

“Activation” or “activating” refers to a process by which a material (e.g., a composite) is mechanically deformed to impart elasticity to at least a portion of the material or composite. Most often, activation is a physical treatment, modification or deformation of the material. For example, the material may be activated by known stretching means. Composite layers of elastomeric films and nonwoven substrates are particularly suited to activation by incremental stretching. As disclosed in the commonly-assigned patent U.S. Pat. No. 5,422,172, which is incorporated by reference, elastomeric composite layers described herein can be activated by incremental stretching using the incremental stretching rollers described therein. Incremental stretching rollers can be used to activate films in the machine direction (MD), cross direction (CD), at an angle, or any combination thereof. A material that has undergone activation is called “activated.”

“Permanent set” is the permanent deformation of the material after removal of an applied load. In the case of elastomeric materials, composites, films, etc., permanent set is the increase in length of a sample of the elastomeric material after the sample has been stretched to a given length and then allowed to relax. Permanent set is typically expressed as a percent increase relative to the original size.

“Post activation set” is the permanent set of an elastic material which has undergone only the stretching associated with activation. The post activation set (PAS) of a material is measured by marking the material before activation with two pen marks separated by a known distance (L₁) in the direction of activation. The material is then activated, and the distance between the two marks is measured again (L₂). The post activation set, as a percent, is calculated by the equation:

PAS (%)=[(L₂−L₁)/L₁]×100

“Transparency” refers to the degree a material allows light to pass through without being scattered. A transparent material, such as a film or a composite, permits an image and its color to pass through. Transparency of films and composites, in percent transmittance (% T), may be measured in accordance with ASTM D1746. While no specific threshold of transparency is noted, in one embodiment % T of the film layer is about 35% or more. For example, the % T may be about 40% or more, about 50% or more, about 60% or more, about 70% or more, or about 80% or more. Conversely, “translucency” refers to the degree a material allows scattered light to pass through. A translucent material permits light, but not a detailed image and its color to pass through.

“Opacity” refers to the degree to a material does not permit light to pass through. Opacity is the inverse of translucency and is generally measured in Opacity Units on a scale of 0% to 100%, where 100% is purely opaque. Opacity of polymer films may be measured using an opacity meter such as model RT-6000 (Qualitest International, Inc.) or an equivalent device. Opacity of composite layers may be measured in accordance with the procedure described in U.S. Patent Application Publication No. 2012/0177886. While no specific threshold of opacity is noted, it may be desirable for the film, composite layer, and/or composite sheet material to have an opacity of about 40 or more, as measured by the Opacity Measurement Method set forth in U.S. Patent Application Publication No. 2012/0177886.

“Absorbent article” refers to devices that absorb and contain body exudates, and, more specifically, refers to devices that are placed against or in proximity to the body of the wearer to absorb and contain the various exudates discharged from the body. Absorbent articles may include diapers, training pants, adult incontinence undergarments, feminine hygiene products, breast pads, care mats, bibs, wound dressing products, and the like. As used herein, the term “body fluids” or “body exudates” includes, but is not limited to, urine, blood, vaginal discharges, breast milk, sweat and fecal matter.

In accordance with embodiments of the present invention, a printed, multi-layered, elastomeric composite sheet material is provided that includes a printed composite layer comprising an elastomeric film that is printed on the free surface, and a substrate layer, typically a nonwoven material, bonded to the other film surface. In accordance with embodiments of the present invention, the printed, multi-layered, elastomeric composite sheet material further includes a second composite layer bonded over the printed free film surface, in order to protect the printed surface from rubbing or smearing. The printed composite layer may be adhesively bonded to the second composite layer. Alternatively, the printed composite layer may be extrusion bonded to the second composite layer. The printed, multi-layered, composite sheet materials described herein may be suitable for use in or more component parts of an absorbent article, for example in a waist band of diapers, training pants, and/or adult incontinence undergarments.

In accordance with embodiments of the present invention, each composite layer may have a total basis weight ranging from about 5 gsm to about 80 gsm, with the film ranging from about 1 gsm to about 35 gsm, and the substrate layer between about 5 gsm to about 60 gsm. For example, the total basis weight may range from about 10 gsm to about 60 gsm, with the film ranging from about 5 gsm to about 30 gsm, and the nonwoven between about 5 gsm to about 60 gsm. For structures comprising two composite layers, the composite layers are brought into contact and bonded on their free film surfaces, and the total basis weight of the composite layer will range from about 20 to about 120 gsm.

In accordance with an embodiment of the present invention, the printed, multi-layered, elastomeric composite sheet material comprises two composite layers bonded with the free film surfaces of both composite layers facing one another. This structure may be called a “dual composite” or “multi-layered composite sheet material.” The composite sheet material may be constructed with either the same composite layers, or two different composite layers made of different films or substrates (e.g., nonwovens). The composite layers used are preferably the extrusion type, where process simplification and cost savings are derived both from the elimination of adhesive and the ability to use lower basis weight spunbond nonwovens. The composite layers may also be made by adhesive lamination. The composites may comprise a monolayer film or a multi-layer film such as a coextruded three-layer film.

In another embodiment, the inventive the printed, multi-layered, elastomeric composite sheet material comprises two different composite layers bonded with the free film surfaces of both composites facing one another. For example, the film of the printed elastomeric composite layer may comprise an opaque elastomeric film, and the second composite layer may comprise a transparent film layer. Alternatively, the film of the printed elastomeric composite layer may comprise a transparent elastomeric film, and the second composite layer may comprise an opaque film layer. In either embodiment, the opaque film enhances the appearance of the printed graphics and the transparent film layer allows the graphics to be visible.

The elastomeric polymers used in the printed elastomeric film layer of this invention may comprise any extrudable elastomeric polymer resin. Examples of such elastomeric polymer resins include block copolymers of vinyl arylene and conjugated diene monomers, natural rubbers, polyurethane rubbers, polyester rubbers, elastomeric polyolefins and polyolefin blends, elastomeric polyamides, or the like. The elastomeric film may also comprise a blend of two or more elastomeric polymers of the types previously described.

For instance, one useful group of elastomeric polymers are the block copolymers of vinyl arylene and conjugated diene monomers, such as AB, ABA, ABC, or ABCA block copolymers where the A segments comprise arylenes such as polystyrene and the B and C segments comprise dienes such as butadiene or isoprene. A similar group of elastomeric polymers are the block copolymers of vinyl arylene and hydrogenated olefin monomers, such as AB, ABA, ABC, or ABCA block copolymers where the A segments comprise arylenes such as polystyrene and the B and C segments comprise saturated olefins such as ethylene, propylene, or butylene. Examples of such elastomeric polymers, known generically as styrene block copolymers (SBCs), include such polymers as styrene-butadiene-styrene (SBS), styrene-isoprene-styrene (SIS), styrene-ethylenebutylene-styrene (SEBS), styrene-ethylene-propylene (SEP), styrene-ethylene-propylene-styrene (SEPS), or styrene-ethylene-ethylene-propylene-styrene (SEEPS) block copolymer elastomers, or blends thereof. It is well known that SBC elastomers exhibit superior elastomeric properties. Suitable SBC resins are readily available from: KRATON® Polymers of Houston, Tex.; Dexco™ Polymers LP of Plaquemine, La.; or Septon™ Company of America of Pasadena, Tex.

The use of SBC elastomers in an elastomeric film yields a film that has excellent stretch and recovery characteristics. However, unsaturated SBC elastomers are prone to thermal degradation when they are overheated, and saturated SBC's tend to be very expensive. In addition, SBC's can be difficult to process and extrude into films, especially thin films of the present invention.

Another useful group of elastomeric polymers are olefin-based elastomers. In a preferred embodiment, the elastomeric film comprises a polyolefinic elastomer (POE). Examples of POEs include olefin block copolymers (OBCs) which are elastomeric copolymers of polyethylene, sold under the trade name INFUSE™ by The Dow Chemical Company of Midland, Mich. Other examples of POEs are copolymers of polypropylene and polyethylene, sold under the trade name VISTAMAXX® by Exxon Mobil Chemical Company of Houston, Tex.

These POEs exhibit greater heat stability than unsaturated SBC elastomers, so a film comprising POEs can be extruded at higher temperatures and lower viscosity. POEs have processability characteristics more like standard nonelastomeric polyolefins, and therefore they are easier to extrude as thin films. Finally, the POEs are chemically similar to the polyolefins used for nonwovens. This chemical similarity improves the chemical affinity between the film layer and nonwoven layer(s) in the composite layer. Hence the composite layer has an improved bond strength due to chemical adhesion in addition to mechanical bonding.

For the elastomeric film, other polymers may be blended into the compositions to enhance desired properties. For example, a linear low-density polyethylene may be added to the film composition to lower the viscosity of the polymer melt and enhance the processability of the extruded film. High-density polyethylene may be added to prevent age-related degradation of the other polymers. High impact polystyrene (HIPS) has been found to control the film modulus, improve the toughness of the film, and reduce the overall cost of the elastomeric material. Polypropylene has been found to improve the robustness of the elastomer and improve the films' resistance to pinholing and tearing.

The elastomeric films of the present invention may optionally comprise other components to modify the film properties, aid in the processing of the film, or modify the appearance of the film. Viscosity-reducing polymers and plasticizers may be added as processing aids. Antiblocking agents may be added to the film to prevent blocking during manufacture or storage. Other additives such as pigments, dyes, antioxidants, antistatic agents, slip agents, foaming agents, heat or light stabilizers, UV stabilizers, and inorganic or organic fillers may be added. In multilayer films, these additives may optionally be present in one, several, or all layers of the film.

In a preferred embodiment, the printed film layer of the composite layer may comprise a opaque film comprising either a pigment, an opacifying agent, or both. The opaque film is particularly effective in showing the printed graphics. Titanium oxide (TiO₂) is a particularly useful and effective additive for opacifying and whitening the printed film layer. In some applications, a high opacity may be a desirable aesthetic property of films or substrates that are incorporated into absorbent articles such as disposable undergarments. High opacity provides the consumer with the impression that the absorbent article will have favorable liquid-retention properties. Accordingly, in one embodiment, the opacity of at least one of the film layers in the composite sheet material or the entire composite may be about 55% or higher. For example the opacity may be about 55% to about 75%.

The elastomeric film layer of the composite layer may comprise a multilayer film, such as a coextruded multilayer film with an ABA-type, an ABCBA-type, or an ABCA-type construction. In this case, the A layers comprise the same composition, and form the outer layers of the film, which are also called the ‘skin’ or ‘surface’ layers. The B layer(s), which forms the so-called ‘core’ or ‘inner’ layer, may be the same composition as the A layers, or the B layer may comprise a composition other than the A layers. The C layer(s), which forms one or more additional polymeric layers that are with the inner layers, may be identical to the A layers or the B layer(s), or the C layer(s) may comprise a composition other than the A or B layers. Each layer of a multilayer elastomeric film may comprise elastomeric polymers, or the layers may comprise either elastomeric, plastoelastic, or plastic non-elastomeric polymers, either singly or in combination, in each layer. The only limitations are that at least one layer of the multilayer elastomeric film must comprise an elastomeric polymer and the multilayer elastomeric film as a whole must be an elastomeric film.

For the A layers of the multilayer film of ABA, ABCBA, or other multilayer construction, these A layers may comprise a polyolefin polymer. The A layers may also comprise an elastomeric polymer. For the A layers, the use of polyolefin-based elastomers may be desired. It has been discovered that A layers containing POE's improve the processability of the elastomeric film, as discussed above, even when the core layer is an SBC or other less processable polymer. POE's on the surface of the film may have a greater chemical affinity for a polyolefinic nonwoven joined to the surface of the film in the composite layer. This greater chemical affinity may improve the composite layer strength between the film surface and a nonwoven layer.

For the B, or core, layer(s) of the ABA, ABCBA, or other multilayer elastomeric film, the core may comprise any elastomeric polymer. In one embodiment, the core layer(s) may be an SBC, such as SBS, SIS, SEBS, SEP, SEPS, or SEEPS block copolymer elastomers, or blends thereof. In another embodiment, the inner B layer(s) of the multilayer film may be a thermoplastic polyolefin, such as the POE's mentioned above, including OBC's such as Infuse™ and PP/PE copolymers such as Vistamaxx®, and combinations thereof. In another embodiment, the inner B layer(s) of the multilayer film may comprise a blend of SBC and a POE. In another embodiment, the inner B layer(s) of the multilayer film may comprise a blend of SBC and a plastoelastic polymer. In another embodiment, the inner B layer(s) of the multilayer film may comprise a blend of SBC and a plastic polymer.

Any film-forming process can prepare the elastomeric film. Preferably, an extrusion process, such as cast extrusion or blown-film extrusion forms the film. Such processes are well known. For example, if the elastomeric film is a multilayer film, the film can be formed by a coextrusion process. Coextrusion of multilayer films by cast or blown processes are also well known.

In order to manufacture a thin-gauge elastomeric film, the average basis weight of the elastomeric film must be controlled. If a polymer is hard to process, then the extruded film of that polymer will be hard to control. This lack of control is seen in problems like fluctuating basis weights, draw resonance, web tear-offs, and other significant problems. As discussed above, SBC elastomers tend to have relatively poor processability, and hence it is very hard to manufacture a film with a controlled basis weight. These problems are only magnified as one attempts to manufacture films with lower basis weights.

However, by extruding films comprising POE polymers or, alternatively, POE polymer skins, the processability of the elastomeric film is improved, and the problems associated with basis weight control are reduced or eliminated. The inventor has discovered that thin-gauge films are much easier to manufacture, even with high concentrations of SBCs in the core layer, when POE polymers comprise the film skin layers.

Another problem with manufacturing lower basis-weight films is their reduced mass, which causes the extruded polymer web to solidify more rapidly. If the extruded polymer web solidifies too quickly, then the polymer film is ‘locked’ into the thickness that exists at that time. This situation is directly comparable to the ‘frost line’ experienced in blown film technology. Once the film has solidified, it cannot be easily drawn to a thinner gauge. Rapid cooling due to lower mass is particularly a problem with elastomers like unsaturated SBCs, which are prone to thermal degradation when heated to excessively high temperatures. Simply heating the unsaturated SBC to a higher temperature to compensate for the reduced mass of the extruded web is not feasible.

On the other hand, POE elastomeric polymers are more thermally stable than SBC elastomers, and thus can be heated to a higher temperature. This increases the total heat present in the extruded polymer web, so the web must release more heat before solidifying. POE's also solidify at lower temperatures than do SBC's, so there is a greater differential between the temperature of the extruded polymer and the temperature at which the film solidifies. Coextruding an SBC-based core within POE-based skin layers both allows the coextruded multilayer film to be extruded at a higher overall temperature, thereby compensating somewhat for the reduced-mass heat loss, and also increasing the time it takes for the extruded molten web to solidify. This allows the manufacturer to extrude the multilayer elastomeric polymer web and draw the web to a lower basis weight before the web solidifies.

It may be desirable for certain aspects of the present invention to use an elastic film that is less than about 65 gsm, or less than about 40 gsm, or less than about 30 gsm, or less than about 20 gsm, or less than about 15 gsm, or less than about 10 gsm, but greater than about 1 gsm or about 5 gsm. Elastic films of the present invention may have a thickness or caliper (also known as z-direction thickness) in the range of about 1 μm to about 65 μm, or from about 1 μm to about 40 μm, or from about 1 μm to about 30 μm, or from about 1 μm to about 20 μm, or from about 1 μm to about 15 μm, or from about 1 μm to about 10 μm.

In one embodiment of the present invention, a composite layer is formed by extrusion lamination of an elastomeric film onto a substrate layer such as a nonwoven material. In another embodiment, the composite layer is formed by adhesive lamination of the elastomeric film onto a substrate layer such as a nonwoven material.

The nonwoven materials typically used to make the elastomeric composite layer of the present invention are generally formed from fibers, which are interlaid in a random fashion. Examples of suitable nonwoven materials include spunbond, carded, meltblown, and spunlaced nonwoven webs. In some embodiments, the nonwoven material may include multiple layers of fibers. For instance, a nonwoven material may comprise a single layer of spunbond fibers (S) or multiple layers of spunbond fibers (SSS). In other embodiments, the nonwoven material may comprise layers of fibers that differ in diameter or composition, such as spunbond-meltblown-spunbond (SMS) nonwovens. Other multilayer nonwoven materials, such as SMMS, SSMMS, etc. may be used.

These nonwoven materials may comprise fibers of polyolefins such as polypropylene or polyethylene, polyesters, polyamides, polyurethanes, elastomers, rayon, cellulose, copolymers thereof, or blends thereof or mixtures thereof. The nonwoven materials may also comprise fibers that are homogenous structures or comprise bicomponent structures such as sheath/core, side-by-side, islands-in-the- sea, segmented pie, and other known bicomponent configurations. For a detailed description of nonwovens, see “Nonwoven Fabric Primer and Reference Sampler” by E. A. Vaughn, Association of the Nonwoven Fabrics Industry, 3d Edition (1992). A preferred nonwoven material comprises bicomponent fibers of sheath-core construction, where the fiber sheath comprises polyethylene and the fiber core comprises polypropylene. Another preferred nonwoven material comprises bicomponent fibers of sheath-core construction, where the fiber sheath comprises polyethylene and the fiber core comprises polyethylene terephthalate ester (PET).

Such nonwoven materials typically have a weight of about 5 grams per square meter (gsm) to 75 gsm. In a preferred embodiment, the nonwoven material should have a basis weight of less than about 30 gsm, about 25 gsm, about 20 gsm, about 15 gsm, or about 10 gsm, in keeping with the thin gauge of the elastomeric film. The nonwoven materials may also comprise fibers of all shapes. The inventor has found that nonwoven materials with “flat” fibers, such as fibers that are rectangular or oblong in cross section, tend to bond better to the elastomeric film than nonwoven materials with fibers that are circular in cross section. Alternatively, notched fibers, such as trilobal or multilobal fibers, may be used.

With respect to the second composite layer, the second film layer and the second substrate layer may include those materials described above for the printed composite layer. Thus, in one embodiment, the second film layer also comprises an elastomeric film bonded to a nonwoven material. Alternatively, the second film layer may comprise a non-elastomeric film bonded to a substrate layer. Exemplary non-elastomeric films comprise a polyolefinic film, which may include a polyolefinic polymer such as polyethylene, polypropylene, copolymer of ethylene and propylene, ethyl vinyl acetate, poly(ethylene terephthalate), or combinations thereof, for example.

Any printing technique may be employed to apply an ink to the free surface of the elastomeric film, such as gravure printing, flexographic printing, screen printing, ink-jet printing, laser printing, thermal ribbon printing, piston printing, etc. In one particular embodiment, flexographic printing techniques are employed to apply the ink to the free surface of the elastomeric film.

The particular type or style of ink pattern or graphic is not a limiting factor of the invention, and may include, for example, any arrangement of stripes, bands, dots, or other geometric shape. The graphic may include indicia (e.g., trademarks, text, and logos), floral designs, abstract designs, any configuration of artwork, etc. The graphic may be targeted for a specific class of consumers. For example, in the case of diapers or training pants, the graphic may be in the form of cartoon characters, and so forth. It should be appreciated that the “graphic” may take on virtually any desired appearance. Nevertheless, the ink may cover from about 5% to 100% of the surface area of the free surface of the elastomeric film, in some embodiments from about 20% to about 90% of the surface area of the film, and in some embodiments, from about 30% to about 50% of the surface area of the film.

The ink generally includes one or more colorants (e.g., pigments, dyes, etc.) that impart a certain color to the facing, such as black, white, yellow, cyan, magenta, red, green, blue, etc. For example, the colorant may be an inorganic and/or organic pigment. Some examples of commercially available organic pigments that may be used in the present invention include those that are available from Clariant Corp. of Charlotte, N.C., under the trade designations GRAPHTOL® or CARTAREN®. Other pigments, such as lake compounds (blue lake, red lake, yellow lake, etc.), may also be employed. Inorganic and/or organic dyes may also be utilized as a colorant. Exemplary organic dye classes include triarylmethyl dyes, monoazo dyes, thiazine dyes, oxazine dyes, naphthalimide dyes, azine dyes, cyanine dyes, indigo dyes, coumarin dyes, benzimidazole dyes, paraquinoidal dyes, fluorescein dyes, diazonium salt dyes, azoic diazo dyes, phenylenediamine dyes, diazo dyes, anthraquinone dyes, trisazo dyes, xanthene dyes, proflavine dyes, sulfonaphthalein dyes, phthalocyanine dyes, carotenoid dyes, carminic acid dyes, azure dyes, acridine dyes, and so forth. One particularly suitable class of dyes includes anthraquinone compounds, which may be classified for identification by their Color Index (CI) number. For instance, some suitable anthraquinones that may be used in the present invention, as classified by their “CI” number, include Acid Black 48, Acid Blue 25 (D&C Green No. 5), Acid Blue 40, Acid Blue 41, Acid Blue 45, Acid Blue 129, Acid Green 25, Acid Green 27, Acid Green 41, Mordant Red 11 (Alizarin), Mordant Black 13 (Alizarin Blue Black B), Mordant Red 3 (Alizarin Red S), Mordant Violet 5 (Alizarin Violet 3R), Natural Red 4 (Carminic Acid), Disperse Blue 1, Disperse Blue 3, Disperse Blue 14, Natural Red 16 (Purpurin), Natural Red 8, Reactive Blue 2, and so forth.

Prior to application, the colorant is typically dissolved or dispersed in a solvent to form the ink. Any solvent capable of dispersing or dissolving the components is suitable, for example water; alcohols such as ethanol or methanol; dimethylformamide; dimethyl sulfoxide; hydrocarbons such as pentane, butane, heptane, hexane, toluene and xylene; ethers such as diethyl ether and tetrahydrofuran; ketones and aldehydes such as acetone and methyl ethyl ketone; acids such as acetic acid and formic acid; and halogenated solvents such as dichloromethane. The concentration of solvent in the ink formulation is generally high enough to allow easy application, handling, etc. Although the actual concentration of solvent employed will generally depend on the type of ink and the elastomeric on which it is applied, it is nonetheless typically present in an amount from about 40 wt. % to about 99 wt. %, in some embodiments from about 50 wt. % to about 95 wt. %, and in some embodiments, from about 60 wt. % to about 90 wt. % of the ink (prior to drying). The colorant may likewise constitute from about 0.01 to about 20 wt. %, in some embodiments from about 0.01 wt. % to about 10 wt. %, in some embodiments, from about 0.05 wt. % to about 5 wt. %, and in some embodiments, from about 0.1 wt. % to about 3 wt. % of the ink (prior to drying).

The ink may also include various other components as is well known in the art, such as colorant stabilizers, photoinitiators, binders, solvents, surfactants, humectants, biocides or biostats, electrolytic salts, pH adjusters, etc. For example, examples of such humectants include, but are not limited to, ethylene glycol; diethylene glycol; glycerine; polyethylene glycol 200, 400, and 600; propane 1,3 diol; propylene-glycolmonomethyl ethers, such as Dowanol PM (Gallade Chemical Inc., Santa Ana, Calif.); polyhydric alcohols; or combinations thereof. Other additives may also be included to improve ink performance, such as a chelating agent to sequester metal ions that could become involved in chemical reactions over time, a corrosion inhibitor to help protect metal components of the printer or ink delivery system, a biocide or biostat to control unwanted bacterial, fungal, or yeast growth in the ink, and a surfactant to adjust the ink surface tension.

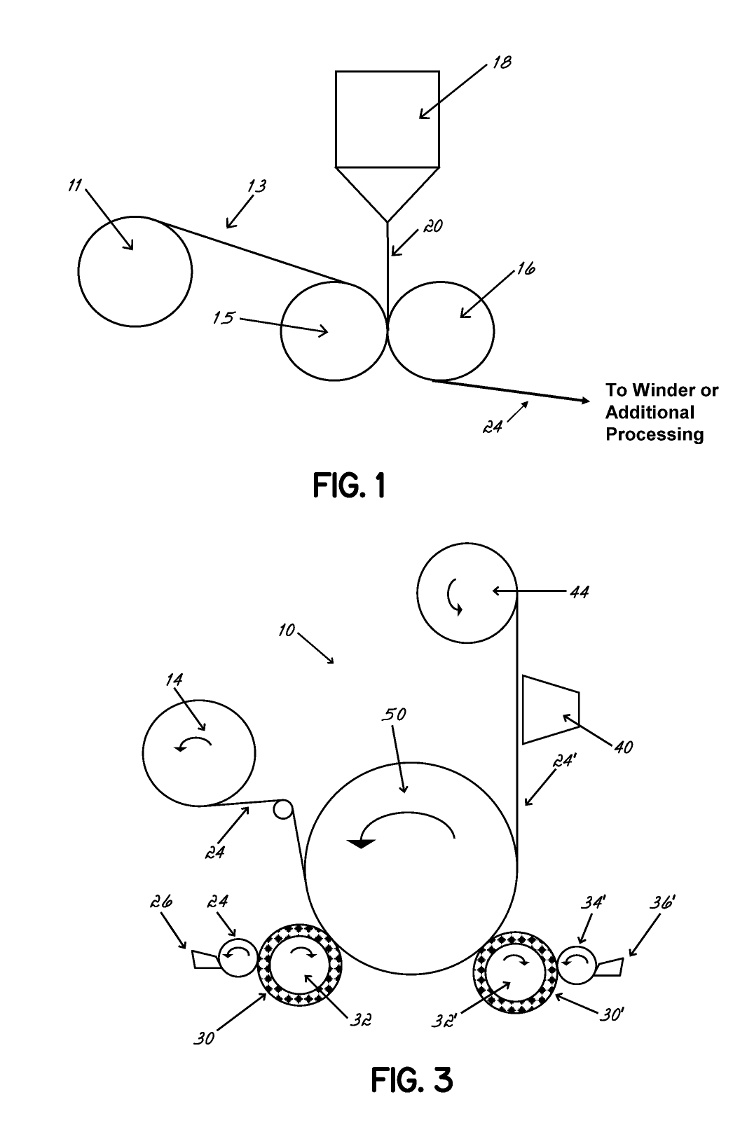

FIG. 1 illustrates a schematic for a typical cast extrusion lamination process. This process can be used to form the composite layer that is used in the present invention. A polymer composition for the elastomeric film is melted in a conventional screw extruder and extruded from the extrusion die 18 to form a molten polymer web 20. The molten polymer web 20 is extruded into the nip between the illustrated metal roll 30 and backing roll 32. The metal roll may be chilled to rapidly cool the molten polymer film. The metal roll 30 may also be engraved with an embossing pattern if such a pattern is desired on the resulting film. The fabric layer 13 of the elastomeric composite layer is unwound from roll 11 and introduced into the nip between the metal and rubber rolls as well. The extruded film layer 20 and fabric layer 13 are pressed together at the nip to bond the layers. The elastomeric composite 24 may now be wound into a roll or go on for further processing.

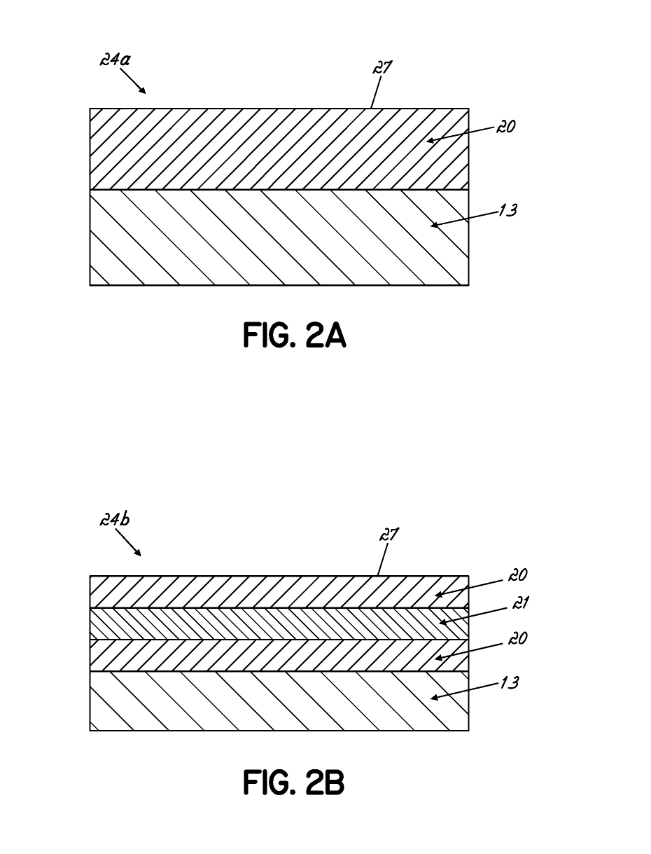

FIGS. 2A and 2B illustrate several embodiments of composite layers that can be generated in the extrusion lamination process represented in FIG. 1. FIG. 2A illustrates a composite layer 24a comprising a monolayer elastomeric film layer 20 which is bonded to a fabric layer 13. FIG. 2B illustrates a composite layer 24b comprising a multilayer ABA elastomeric film with outer A layers 20 and core B layer 21, which is bonded to the fabric layer 13.

It should be noted that, for a composite layer, such as one of the embodiments shown in FIGS. 2A, 2B, the substrate layer 13 serves to stabilize the composite and substantially reduces the inherent elasticity of the material. This is true whether the film layer of the composite is a monolayer film, 20, as shown in FIG. 2A, or a multilayer film, 20/21/20, as shown in FIG. 2B. At this stage, the composite layer is effectively stabilized, and the inventor has determined that it is possible to print the free film surface of the composite layer with great precision, and achieve excellent-quality printed graphics.

However, it should be further appreciated that composite layer 24 may be subjected to some degree of activation prior to printing. While activation in the machine direction (MD) is not prohibited, activation in the machine direction “destabilizes” the composite layer. Thus, MD-activation imparts a degree of machine direction elasticity in the composite layer, which may compromise graphics quality during the subsequent printing process. Accordingly, in a preferred embodiment, if activation of the composite layer 24 is performed prior to printing, activation in the cross-direction (CD) only may be performed so as to preserve MD-stabilization. Alternatively, activation may be performed after printing to impart the desired elasticity to the printed composite layer 24′. In yet another alternative embodiment, activation may be performed on the inventive printed, multi-layered, elastomeric composite sheet material 26.

Once the composite layer is formed, it is printed using a process and apparatus such as is illustrated in FIG. 3. This figure illustrates one style of flexographic printing, involving the use of a central impression (CI) drum 50. The composite layer 24 to be printed is unwound from a roll 14 and guided by idler rolls to pass over the surface of the CI drum 50. Ink from two printing decks are printed on the film side 27 of the composite layer 24. The ink of the first printing deck is held in pan 36, from which the ink is picked up by anilox roll 34 and transferred to the first impression plate 30 which is mounted on roll 32. The first impression plate 30 prints the first ink pattern on the composite layer 24, which is then carried by the CI drum 50 to the second printing deck, where the process in repeated by a second impression plate 30′ on mounting roll 32′ receiving ink from an ink pan 36′ via an anilox roll 34′. Additional printing decks can be installed around the CI drum 50, as desired. Once the printing is completed, the printed composite layer 24′ may then be treated by a drying unit 40 to hasten the drying of the printed ink, then wound into a roll 44.

Once the printed composite layer 24′ is formed, it is bonded to the second composite layer to form the inventive printed multilayer elastomeric composite sheet material. There are many known bonding methods that may be used to bond the printed composite layer 24′ to another composite layer. Such methods include adhesive bonding, extrusion bonding, thermal bonding, ultrasonic bonding, calender bonding, point bonding, and laser bonding. Combinations of bonding methods are also within the scope of the present invention. As described above, the printed composite layer 24′ may be activated prior to bonding to the second composite layer.

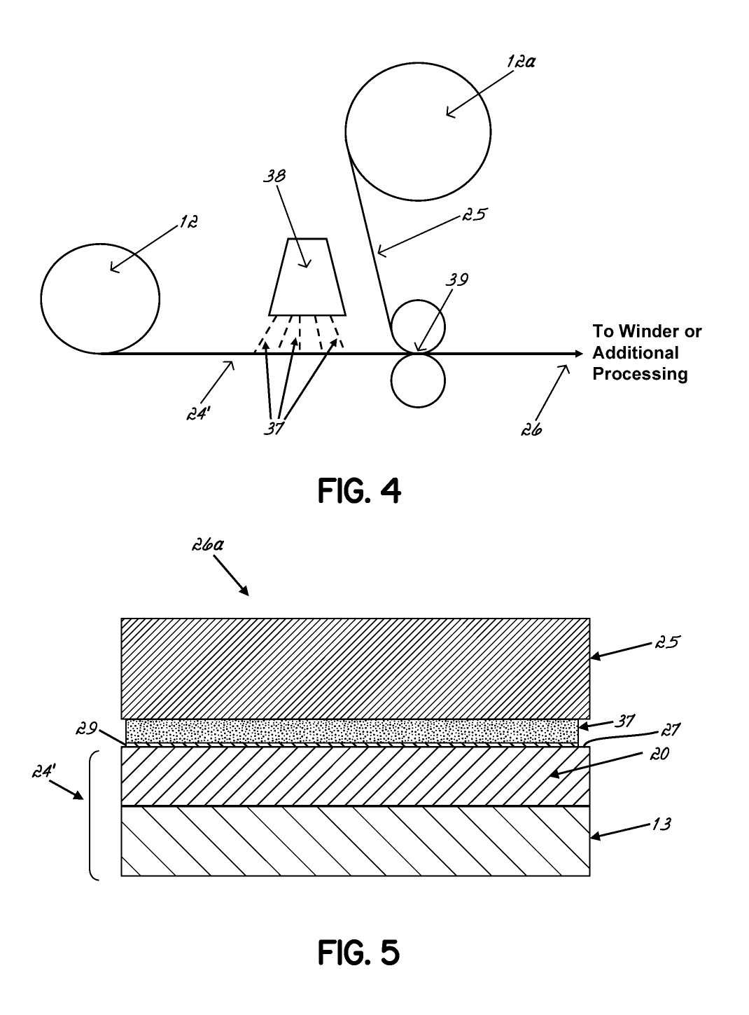

As illustrated in FIG. 4, one preferred method of bonding the composite layers is adhesive lamination. A printed composite layer 24′ is transported from roll 12 (or the extruder) to an adhesive bonding station, where adhesive 37 is applied by means such as a spray unit 38 onto the film surface of the printed composite layer 24′. Alternatively, the spray unit 38 may spray adhesive onto the free film surface of the incoming second composite layer 25 (not shown). The second composite layer 25 is unwound from roll 12a and introduced into a nip 39 that presses the printed composite layer 24′ and the second composite layer 25 to bond the layers and form the composite sheet material 26. The inventive printed, multi-layered, elastomeric composite sheet material 26 may now be wound into a roll or go on for further processing.

It is to be understood that the second composite layer 25, includes a film layer, which may comprise an elastomeric or non-elastomeric film, that is bonded to a substrate layer.

FIG. 5 shows one embodiment of the printed, multi-layered, elastomeric composite sheet material 26a of the present invention. Here, a printed composite layer 24′ comprising a nonwoven layer 13 and a printed monolayer film 20′ with a graphic 29 printed on the film surface 27 is bonded to a second composite layer 25 layer with a layer of adhesive 37. The second composite layer 25 may include a film layer bonded to a nonwoven or other sheetlike material layer. Hence, the final composite sheet material 26a construction is nonwoven 13/printed film 20′/adhesive 37/composite layer 25.

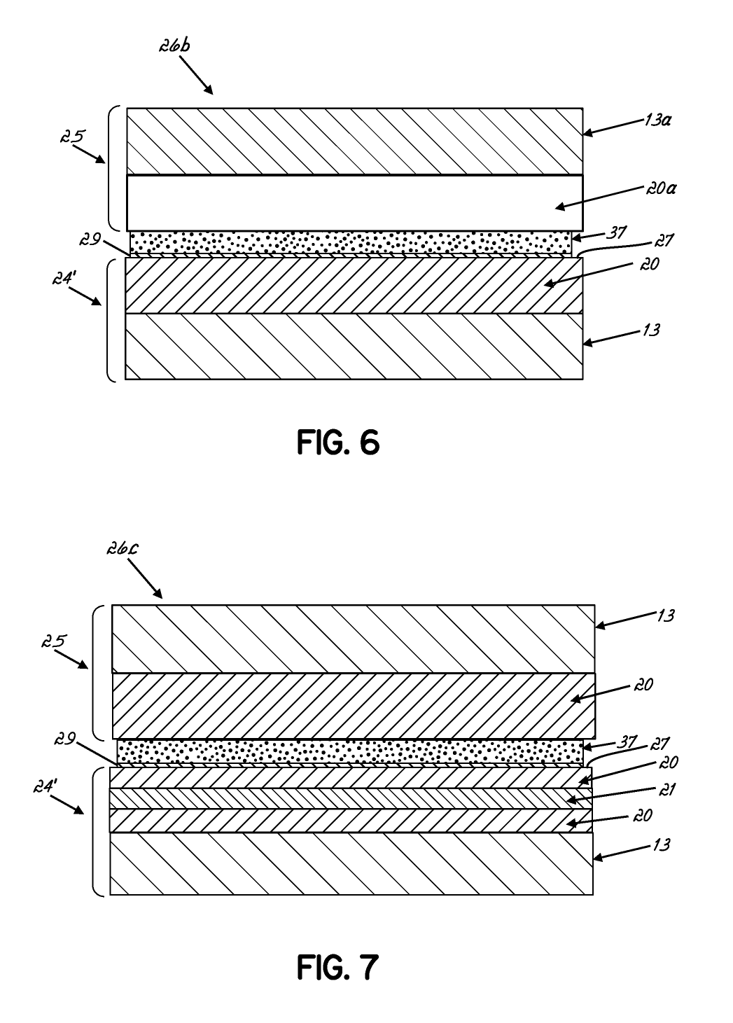

FIG. 6 shows another embodiment of the composite sheet material 26b of the present invention. Here, two different composite layers are bonded together with a layer of adhesive 37. In this embodiment, the first composite layer is a printed composite layer 24′, which comprises a nonwoven layer 13 and a printed monolayer film 20′ with a graphic 29 printed on the film surface 27. The second composite layer 25 is a composite layer that comprises a monolayer film 20a, which may differ from the film layer 20 of the printed composite layer 24′. Similarly, the nonwoven layer 13a of the second composite layer 25 may differ from the nonwoven layer 13 of the printed composite layer 24′. The composite layers are bonded with the adhesive between the film surfaces of each composite. Hence, the final printed multi-layered composite sheet material 26a is nonwoven 13/printed film 20′/adhesive 37/film 20a/nonwoven 13a. It should be further appreciated that while the film layers (20′, 20a) may have differences, e.g., chemical composition, thickness, density, etc., it is further envisioned that may be identical in those respects, too. Similarly, the nonwoven layers (13, 13a) may be different or identical with respect to chemical composition, thickness, and density.

FIG. 7 shows another embodiment of the printed multi-layered composite sheet material 26c of the present invention. Here, two multi-layer composite layers are bonded together with a layer of adhesive 37. In this embodiment, the printed composite layer 24′ comprises a nonwoven layer 13 and a printed multi-layer film 20/21/20′ with a graphic 29 printed on the film surface 27. The second composite layer 25 comprises a monolayer film 20a and a nonwoven layer 13a. The composite layers are bonded with the adhesive 37 between the film surfaces of each composite. Hence, the final composite sheet material 26c structure is nonwoven 13/printed multilayer film 20/21/20′/adhesive 37/monolayer film 20a/nonwoven 13a.

It is to be understood that the individual composite layers or the elastomeric composite sheet material may be subjected to additional processing steps such as activating, aperturing, printing, slitting, laminating additional layers, and other such processes may be added to the inventive process and are within the scope of this invention.

For example, all or portions of the printed, multi-layered elastomeric composite sheet material may be activated to impart elasticity to or enhance the elasticity of the material. Activating the composite sheet material may be achieved by incremental stretching in a machine direction, a cross direction, at an angle, or any combination thereof. Non-limiting examples of suitable depths of engagement (DOE) for activating the composite layers and/or the composite sheet materials may be from about 0.09 inches to about 0.2 inches. For example, the DOE may be about 0.11 inches, about 0.13 inches, about 0.15 inches, about 0.17 inches, or about 0.19 inches.

In accordance with another embodiment of the present invention, the printed, multi-layered composite sheet material is amenable for use in various components of absorbent articles. For example, the inventive composite sheet material's elastic property and high quality printed graphics are especially desirable in waistband regions, side panels, closure, front panel, etc. in diapers, adult incontinence pads, and other similar absorbent articles.

The following examples are presented to illustrate embodiments of the present invention. These examples are not intended to limit the invention in any way.

### EXAMPLE 1

A printed multi-layered, elastomeric composite sheet material of the present invention was prepared and tested for robustness. A first composite layer was made by extrusion lamination. The film component of the composite layer comprised a monolayer elastomeric film comprising approximately 80% Vistamaxx® 6102, from ExxonMobil Chemical, 15% Elite™ 5800 linear low density polyethylene, from The Dow Chemical Company, and 5% white masterbatch concentrate from Schulman Corporation. This elastomeric film was extruded at 10 gsm basis weight and laminated to a 15 gsm bicomponent spunbond nonwoven on a cast-extrusion line. The free film side of the first composite layer was printed with graphic designs.

A second composite layer was also made by extrusion lamination. The film component of the second composite layer comprised a monolayer elastomeric film comprising approximately 82% Vistamaxx® 6102 from ExxonMobil Chemical, and 18% Elite™ 5800 linear low density polyethylene from The Dow Chemical Company. This elastomeric film was extruded at 10 gsm basis weight and laminated to a 15 gsm bi-component spunbond nonwoven on a cast-extrusion line. Layers of the first and second composite layers were then adhesively bonded such that the free film surfaces of the composite layers were facing each other.

The composite sheet material was then activated by incremental stretching at a DOE of 0.160 inches to provide a composite sheet material having an elasticity property as demonstrated by stretching a 10 inch sample to 15 inches, which recovered to less than 12 inches.

### EXAMPLE 2

Another printed, multi-layered, elastomeric composite sheet material in accordance with the present invention may be prepared and activated, as proposed below. For example, a first composite layer may be made by extrusion lamination. The film component of the first composite layer may comprise a multi-layered elastomeric film comprising a core layer of approximately 80% Vistamaxx® 6102 from ExxonMobil Chemical, 15% Elite™ 5800 linear low density polyethylene, from The Dow Chemical Company, and 5% white masterbatch concentrate from Schulman Corporation, which may be co-extruded between two outer layers comprising approximately of 75% Elite™ 5800 linear low density polyethylene, from The Dow Chemical Company, and 25% Dow Infuse™ 9107. This elastomeric film may be extruded at 10 gsm basis weight and laminated to a 15 gsm bicomponent spunbond nonwoven on a cast-extrusion line, for example. The free film side of the first composite layer may then be printed with graphic designs.

A second composite layer may also be made by extrusion lamination. The film component of the second composite layer may comprise a multi-layered elastomeric film comprising a core layer of approximately 80% Vistamaxx® 6102, from ExxonMobil Chemical, 15% Elite™ 5800 linear low density polyethylene, from The Dow Chemical Company, which may also be co-extruded between two outer layers comprising approximately of 75% Elite™ 5800 linear low density polyethylene, from The Dow Chemical Company, and 25% Dow Infuse™ 9107. This elastomeric film may also be extruded at 10 gsm basis weight and laminated to a 15 gsm bicomponent spunbond nonwoven on a cast-extrusion line, for example. Layers of the first and second composite layers may then be adhesively bonded such that the free film surfaces of the composite layers are facing each other.

The composite sheet material can then be activated by incremental stretching at a DOE of 0.160 inches to provide a composite sheet material having the desired elasticity property, which may be confirmed by stretching a 10 inch sample to 15 inches, and the stretched sample recovering to 12 inches or less.

While the present invention has been illustrated by the description of embodiments, and while the illustrative embodiments have been described in considerable detail, it is not the intention of the inventors to restrict or in any way limit the scope of the appended claims to such detail. Additional advantages and modifications readily will appear to those skilled in the art. The invention in its broader aspects is therefore not limited to the specific details, representative apparatus and methods, and illustrative examples shown and described. Accordingly, departures may be made from such details without departing from the scope of the inventors' general inventive concept.

What is claimed is:

1. A printed, multi-layered, elastomeric composite sheet material, comprising:
a first composite layer, comprising a first film layer comprising a first elastomeric polymer bonded to a first substrate layer, wherein the first composite layer has a first film surface and a first substrate surface, and wherein a printed graphic is on the first film surface; and
a second composite layer, comprising a second film layer bonded to a second substrate layer, wherein the second composite layer has a second film surface and a second substrate surface;
wherein the first composite layer and the second composite layer are bonded across at least a portion of the first and second film surfaces.

2. The composite sheet material according to claim 1, wherein the first film layer and the first substrate layer of the first composite layer, and the second film layer and the second substrate layer of the second composite layer are bonded by extrusion lamination, adhesive lamination, thermal lamination, ultrasonic lamination, calender lamination, or combinations thereof.

3. The composite sheet material according to claim 1, wherein the first composite layer and the second composite layer are adhesively bonded together by adhesive lamination.

4. The composite sheet material according to claim 1, wherein the first and second substrate layers of the first and second composite layers comprise nonwoven materials.

5. The composite sheet material according to claim 1, wherein the first film layer, the second film layer, or both comprise multi-layer films.

6. The composite sheet material according to claim 1, wherein the second film layer comprises a second elastomeric polymer.

7. The composite sheet material according to claim 6, wherein the first and second elastomeric polymers are independently selected from the group consisting of styrenic block copolymers, polyolefinic elastomers, combinations thereof, and blends thereof.

8. The composite sheet material according to claim 1, wherein the second film layer comprises a non-elastomeric film.

9. The composite sheet material according to claim 1, wherein the first or second film layer has an opacity equal to or greater than 40%.

10. The composite sheet material according to claim 1, wherein the first film layer has a percent transmittance (% T) equal to or greater than 35%; and wherein the second film layer has an opacity equal to or greater than 40.

11. The composite sheet material according to claim 1, wherein the graphic printed on the first film surface covers from about 5% to about 100% of the first film surface.

12. The composite sheet material according to claim 1, wherein at least one of the first composite layer or the second composite layer was activated prior to being bonded across at least the portion of the first and second film surfaces.

13. The composite sheet material according to claim 1, wherein the composite sheet material has been activated by incremental stretching in a machine direction, a cross direction, at an angle, or any combination thereof.

14. The composite sheet material according to claim 1, wherein the first and second composite layers each have a total film basis weight from about 10 gsm to about 60 gsm.

15. A method of making a printed, multi-layered, elastomeric composite sheet material, comprising
printing a graphic on a first composite layer, wherein the first composite layer comprises a first film layer comprising a first elastomeric polymer bonded to a first substrate layer, wherein the first composite layer has a first film surface and a first substrate surface, and wherein the graphic is printed on the first film surface; and
bonding the first composite layer to a second composite layer comprising a second film layer and a second substrate layer, wherein the first and second film surfaces of the first and second composite layers are bonded across at least a portion of the film surfaces.

16. The method according to claim 15, further comprising:
forming the first composite layer by bonding the first film layer to the first substrate layer; or
forming the second composite layer by bonding the second film layer to the second substrate layer.

17. The method according to claim 16, wherein the first film layer and the first substrate layer of the first composite layer, and the second film layer and the second substrate layer of the second composite layer are bonded by extrusion lamination, adhesive lamination, thermal lamination, ultrasonic lamination, calender lamination, or combinations thereof.

18. The method according to claim 15, wherein the first film layer, the second film layer, or both comprise multi-layer films.

19. The method according to claim 15, wherein bonding the first composite layer to the second composite layer comprises:
applying an adhesive composition to at least one of the first or second film surfaces; and
pressing the first and second film surfaces together to sandwich the adhesive composition therebetween and thereby adhesively bond the first and second composite layers together.

20. The method according to claim 15, further comprising activating the printed, multi-layered, elastomeric composite sheet material by incremental stretching in a machine direction, a cross direction, at an angle, or any combination thereof.
